(19) United States
(12) Patent Application Publication
(10) Pub. No.: US 2022/0388376 A1
(43) Pub. Date: Dec. 8, 2022

(54) Vehicle window for a vehicle and method for producing said vehicle window

(71) Applicant: Sisecam Automotive Germany GmbH, Besigheim (DE)

(72) Inventor: ERWIN BUTSCH, WINNENDEN (DE)

(21) Appl. No.: 17/804,573

(22) Filed: May 30, 2022

(30) Foreign Application Priority Data
Jun. 7, 2021 (DE) DE102021114562.7

(51) Int. Cl. B60J 1/00

(52) U.S. Cl. CPC B60J 1/008

(57) ABSTRACT

The invention relates to a vehicle window for a vehicle and to a method for producing said vehicle window, comprising a glass body, which has an inside and an outside, which are spaced apart by a wall thickness of the glass body, comprising an externally peripheral edge that delimits the glass body, wherein the glass body comprises a planar extent that extends in a two-dimensional plane or a spherically curved plane, wherein the glass body has a three-dimensionally shaped functional region having a free form that bulges with respect to the plane of the glass body, and the glass body having the three-dimensionally shaped functional region is produced from a pressed glass.

### CROSS REFERENCE TO RELATED APPLICATIONS

This application claims priority to German patent application DE102021114562.7 by the same inventor and filed on 7 Jun. 2021.

### STATEMENT REGARDING FEDERALLY SPONSORED RESEARCH OR DEVELOPMENT

Not Applicable.

### BACKGROUND OF THE INVENTION

### Technical Field

The invention relates to a vehicle window for a vehicle, and to a method for producing a vehicle window of this kind.

### Related Background Art

A vehicle, in particular a motor vehicle, comprises side windows that are installed either in doors so as to be movable up and down or as stationary elements in the bodywork. In addition, vehicles can comprise windows that provide a view backwards. These side windows and/or rear windows are produced from a float glass as a safety glass. In some applications, and also to reduce weight, they can be made of plastics material. In the case of windows of this kind made of plastics material, it is possible to also shape these windows in a three-dimensional manner, as a result of which specific design demands can be met. However, windows of this kind produced from plastics material have the disadvantage whereby they are become unroadworthy and tarnished after a relatively long period of use, by contrast with windows made of float glass as a safety glass. However, the windows produced from float/safety glass are disadvantageous in that they do not allow for any three-dimensional deforming, but rather extend in a two-dimensional plane or can only be slightly curved.

### BRIEF SUMMARY OF THE INVENTION

The object of the invention is to propose a vehicle window for a vehicle and a method for producing a vehicle window of this kind so that greater freedom of design for the shape of the windows and also a long service life are made possible.

This object is achieved by a vehicle window for a vehicle, which vehicle window has a glass body, on which a three-dimensionally deformed functional region having a free form is moulded, said functional region bulging with respect to the plane of the glass body, and the glass body and the integrated three-dimensionally deformed functional region are produced from a pressed glass. Using pressed glass makes it possible to obtain a long service life compared with vehicle windows made of plastics material, in particular polycarbonate. In addition, producing the glass body, having the integrated functional region, from pressed glass is advantageous in that a design of three-dimensional free forms is made possible. This cannot be implemented in a float/safety glass.

In a vehicle window of this kind, the glass body, which comprises an outside and an inside, which are spaced apart by a wall thickness of the glass body, and is delimited by an externally peripheral edge, can have a planar extent in a two-dimensional plane and also in a spherically curved plane.

In addition, the glass body and the three-dimensionally shaped, integrated functional region are preferably produced from pressed glass by way of primary shaping. This enables cost-effective production of a vehicle window of this kind. Post-treatment, for example reshaping, in order to introduce the three-dimensionally shaped functional region, can be omitted. This production of the vehicle window by primary shaping is also advantageous in that a vehicle window of this kind can be produced to be free of stresses.

In addition, the three-dimensionally shaped functional region preferably protrudes with respect to a planar extent of the glass body. As a result, pre-existing installation conditions, in particular on vehicles, can be retained and an additional function can be added to the vehicle window as a result of said three-dimensionally shaped functional region integrated in the glass body.

Advantageously, in a transition region from the planar extent of the glass body into the three-dimensionally shaped functional region, the same wall thickness as in the planar extent of the glass body is provided. The glass body, the three-dimensionally shaped functional region and a transition region are thus configured to be distortion-free.

The transition region between the planar extent of the glass body and the three-dimensionally shaped functional region is preferably rounded or elliptical. In particular, a step-free arrangement is provided. Owing to smooth transitions of this kind, peak stresses in the transition region between the planar extent of the main body and the three-dimensional functional region can also be reduced.

Alternatively, the three-dimensionally shaped functional region can be formed to have a different wall thickness from the glass body. Preferably, the transition region has a distortion-free through-vision. For example, starting from the two-dimensionally extending glass body, an increase in the thickness of the wall thickness can be provided in the transition region and/or a three-dimensionally shaped functional region compared with the thickness of the two-dimensionally extending glass body, thereby achieving higher stiffness. In addition, the transition region and/or the three-dimensionally shaped functional region can be formed to be thinner than the glass body.

According to a preferred embodiment of the vehicle window, the three-dimensional functional region has an edge portion located in an outer edge of the glass body. As a result, the flexibility in the design, application and introduction of the three-dimensional functional region can be increased.

In particular, the three-dimensionally deformed functional region is formed as a recessed handle that adjoins an outer edge of the two-dimensionally extending glass body. Behind this recessed handle, a door opening mechanism can be provided, which is thus protected against external influences and/or is aerodynamically covered. Moreover, the three-dimensional functional region can be formed as a spoiler or a wind deflector that can be provided not only on a side window but also on a rear window or tailgate. In addition, the three-dimensionally shaped functional region can be used as a design element. For example, an optical distortion can be obtained by wall thickness modifications and/or darkening and/or surface modifications. This can also be a visual effect for privacy, for example.

The glass body of the vehicle window is preferably produced from a soda-lime glass, an aluminium silicate glass or a borosilicate glass. Glasses of this kind allow for production using pressed glass and exhibit high quality in terms of transparency. Colours of any kind, from red to green, blue to yellow, are conceivable and possible, within the values that meet statutory regulations.

The above-described vehicle window can, for example, be formed as a side window in a door of a vehicle, or as a fixed window, in particular a triangular window, preferably between the B-pillar and C-pillar, of a vehicle. A vehicle window of this kind can also be used as a rear window or a tailgate.

The object of the invention is further achieved by a method for producing a vehicle window for vehicles according to one of the above-described embodiments in which the glass body and a three-dimensionally shaped functional region, which has a free form and bulges with respect to the plane of the glass body, is produced from pressed glass by a pressed-glass process. This enables cost-effective production.

In particular, a vehicle window of this kind can be made available for further processing without any finishing. For example, an overmoulding can be applied, which provides covering along the outer edge at least in part and is intended for sealingly arranging the vehicle window in an opening of a bodywork of a vehicle.

In addition, an insert can advantageously be positioned in a mould for producing the vehicle window, and once the pressed glass has been introduced into the vehicle mould the insert is enclosed and retained by the glass body at least in part. As a result, greater flexibility and functionality can be achieved for a vehicle window of this kind.

Preferably, the metal insert is incorporated in the glass body. This makes it possible to increase the functionality.

### BRIEF DESCRIPTION OF THE DRAWINGS

The invention and other advantageous embodiments and developments thereof will be described and explained in more detail below on the basis of the examples shown in the drawings. The features set out in the description and the drawings can be implemented either individually or together in any combination in accordance with the invention. In the drawings:

### BRIEF DESCRIPTION OF THE DRAWINGS

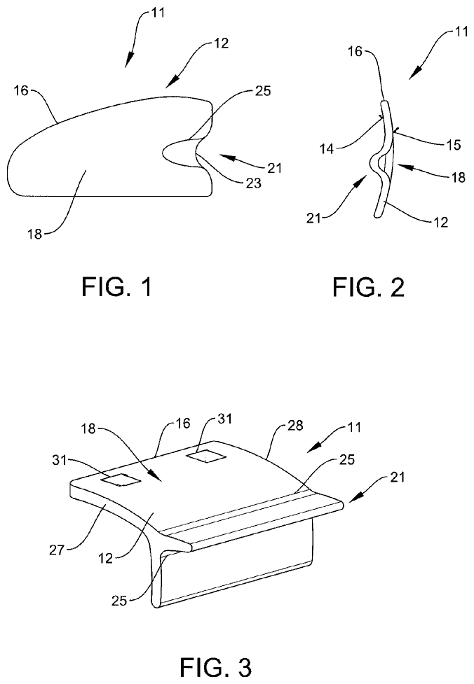

FIG. 1 is a schematic side view of a vehicle window,

FIG. 2 is a schematic side view of the vehicle window according to FIG. 1, and

FIG. 3 is a perspective view of an alternative embodiment of the vehicle window from FIG. 1.

### DETAILED DESCRIPTION OF THE INVENTION

FIG. 1 shows a vehicle window 11. This vehicle window 11 comprises a glass body 12, which has an inside 14 and an outside 15. Said glass body 12 is delimited by an externally peripheral edge 16. The glass body 12 has a planar extent 18. This planar extent 18 is in a two-dimensional plane or is spherically curved. The glass body 12 further comprises a three-dimensionally deformed functional region 21. This three-dimensionally deformed functional region 21 is connected to the glass body 12 in one piece, or they consist of the same material. The glass in this case is a pressed glass, for example soda-lime glass, an aluminium silicate glass or a borosilicate glass. The three-dimensionally shaped functional region 21 is multiple times smaller than the planar extent 18 of the main body 12. In the embodiment example according to FIGS. 1 and 2, the three-dimensionally shaped functional region 21 bulges with respect to an inside 14 of the glass body. Alternatively, it can also be formed to bulge with respect to an outside 15 of the glass body 12. Advantageously, said three-dimensionally shaped functional region 21 is formed so as to adjoin the outer edge 16 by an edge portion 23. Said three-dimensionally shaped functional region 21 has a transition region 25 to the planar extent 18 of the main body 12. Said transition region is formed to be smooth. Preferably, the wall thickness of the glass body 12 is identical in the planar extent 18 of the glass body, in the transition region 25 and in the three-dimensionally shaped functional region 21.

The vehicle window 11 according to FIGS. 1 and 2 is specifically formed as a so-called triangular window, which is preferably installed so as to adjoin a C-pillar of a vehicle. It is a vehicle window 11 installed in a stationary manner in relation to the bodywork. A vehicle door can be provided opposite the three-dimensional functional region 21 or adjoining the edge portion 23, a frame preferably being provided on the vehicle door, which frame extends along the edge portion 23 of the functional region 31 and has an opening mechanism pointing towards the inside of the bodywork. As a result of the three-dimensionally shaped functional region 21, a recessed handle is thus formed, which makes it possible to actuate a locking mechanism arranged in a concealed manner in the side door.

FIG. 3 shows another alternative embodiment of a vehicle window 11. This vehicle window 11 can be a rear window or a tailgate, formed from the glass body 12 and the three-dimensionally shaped functional region 21. Said three-dimensionally shaped functional region 21 is formed as a spoiler. Advantageously, this three-dimensionally shaped functional region 21 can extend along two opposite edge portions 27, 28.

In addition, individual regions of the vehicle window 11, in particular regions that extend along the external peripheral edge 16 and/or also at least in part inside the three-dimensionally shaped functional region 21, preferably have a colouring. For example, regions of the vehicle window 11 can be provided with a black colouring.

In addition, at least one insert 31 can preferably be provided in the vehicle window 11, which insert is enclosed and retained by the glass body 12 at least in part. In the vehicle window 11 according to FIG. 3, the insert 31 can, for example, represent a component of a hinge for a tailgate.

The vehicle window 11 according to the above-described embodiments can comprise an overmoulding of a plastics material that extends at least in part along the peripheral edge 16 of the vehicle window 11. This overmoulding is formed as a seal for sealing an opening in a bodywork of a vehicle with respect to the vehicle window 11.

The embodiments of the vehicle windows 11 described above by way of example are preferably produced by a pressed-glass process. Said vehicle window 11 is thus produced from pressed glass by way of primary shaping. As a result, any designs for shaping the three-dimensionally shaped functional region 21 can be introduced into a planar extent 18 of the glass body 12. Said at least one functional region 21 can also be provided within a planar extent 18 of the glass body 12 at a distance from the peripheral edge 16. One or more three-dimensionally shaped functional regions 21 can be provided in the vehicle window 11.

I claim:

1. A vehicle window for a vehicle,
comprising a glass body, the glass body comprising an inside and an outside, which are spaced apart by a wall thickness of the glass body, and,
comprising an externally peripheral edge that delimits the glass body, wherein the glass body comprises a planar extent that extends in a two-dimensional plane or a spherically curved plane, and,
wherein
the glass body has a three-dimensionally shaped functional region having a free form that bulges with respect to the plane of the glass body, and
the glass body is produced from a pressed glass.

2. The vehicle window according to claim 1, wherein the glass body and the three-dimensionally shaped functional region are produced in one piece from pressed glass by way of primary shaping.

3. The vehicle window according to claim 1, wherein the three-dimensionally shaped functional region protrudes with respect to an inside or an outside of the planar extent of the glass body.

4. The vehicle window according to claim 1, wherein, in a transition region from the planar extent of the glass body into the three-dimensionally shaped functional region, the same wall thickness as in the planar extent of the glass body and/or the three-dimensionally shaped functional region is provided.

5. The vehicle window according to claim 4, wherein the transition region has a rounded or elliptical shape or is formed to be step-free.

6. The vehicle window according to claim 1, wherein the three-dimensionally shaped functional region and/or a transition region from the glass body into the functional region is/are formed so as to have a different wall thickness from one another or from the layer thickness of the glass body, and a distortion-free through-vision is provided.

7. The vehicle window according to claim 1, wherein the three-dimensionally shaped functional region has an edge portion located in the outer edge of the glass body.

8. The vehicle window according to claim 1, wherein the three-dimensionally shaped functional region is formed as a recessed handle, a spoiler or a design element.

9. The vehicle window according to claim 1, wherein the glass body and the at least one three-dimensionally shaped functional region are formed as a side window, a triangular window or a rear window.

10. A method for producing a vehicle window for a vehicle,
the vehicle window having a glass body, which comprises an inside and an outside, which are spaced apart by a wall thickness of the glass body, and,
the vehicle window having an externally peripheral edge that delimits the glass body, wherein the glass body comprises a planar extent that extends in a two-dimensional plane or a spherically curved plane, and,
the method comprising:
producing the glass body from a pressed glass, and,
forming the three-dimensionally shaped functional region with a free form that bulges with respect to the plane of the glass body.

11. The method according to claim 10, wherein at least one insert is positioned in a mould for producing the vehicle window and the at least one insert is enclosed and retained by the glass body at least in part.

12. The method according to claim 10, wherein the glass body is produced, together with the integrated, three-dimensionally shaped functional region, from a soda-lime glass, an aluminium silicate glass or a borosilicate glass.
